(19) United States
(12) Patent Application Publication
(10) Pub. No.: US 2016/0291553 A1
(43) Pub. Date: Oct. 6, 2016

(54) SMART CONTROL APPARATUS AND SMART CONTROL SYSTEM

(71) Applicant: Wei-Chiang HSU, Taipei City (TW)

(72) Inventor: Wei-Chiang HSU, Taipei City (TW)

(73) Assignee: SMARTALL INC., Taipei City (TW)

(21) Appl. No.: 15/087,966

(22) Filed: Mar. 31, 2016

Related U.S. Application Data
(60) Provisional application No. 62/141,470, filed on Apr. 1, 2015.

(51) Int. Cl. G05B 13/02

(52) U.S. Cl. CPC G05B 13/0265

(57) ABSTRACT

A smart control apparatus linking to at least one smart electronic apparatus includes an identifying module, a learning recording module and a control module. The identifying module identifies an identity of at least one user. The learning recording module electrically connected to the identifying module records and learns an operation of the user on the at least one smart electronic apparatus and generates a learning result. The control module linking to the learning recording module generates and transmits a control signal according to the learning result to control the smart electronic apparatus. The smart control apparatus makes the smart electronic apparatus (IOT management apparatus) have corresponding different operations according to a work and rest mode of the user, and enhances the identity identifying security when the user operates the smart electronic apparatus.

### CROSS REFERENCE TO RELATED APPLICATIONS

The non-provisional patent application claims priority to U.S. provisional patent application with Ser. No. 62/141,470 filed on Apr. 1, 2015. This and all other extrinsic materials discussed herein are incorporated by reference in their entirety.

### BACKGROUND OF THE INVENTION

1. Field of Invention

The invention relates to a smart control apparatus and a smart control system, and more particularly to a smart control apparatus having an identity identifying function and different control modes according to a work and rest mode of a user.

2. Related Art

The Internet of things (IOT) and cloud computation have been widely applied to the smart home facility, mobile terminal apparatus, industry system environment and the like. In the Internet era, people can contact one another through the Internet, and can obtain the information of the object through the Internet. The IOT further creates an Internet environment whether the objects can communicate with each other or one another. Meanwhile, the IOT era represents the evolution trends on the computation and communication of the future information technology.

In the modern IOT management apparatus, however, all the functions of identifying the ambient environment condition, the user's operation behavior and the user's identity cannot be satisfied, and a multi-function smart IOT management apparatus that can be adjusted and controlled according to different work and rest modes of the user cannot be provided. Thus, the problem that the IOT management apparatus cannot satisfy the user's expected function arises. In other words, the IOT management apparatus cannot provide the dedicated human-oriented service for the user's operation behavior and habit, or the user cannot make the IOT management apparatus have the corresponding different operations according to his/her work time and rest time, and the security of the IOT management apparatus of identifying the user's identity cannot be enhanced.

Therefore, how to provide dedicated IOT management apparatus for the user's operation behavior and habit, and how to make the IOT management apparatus have the corresponding different operations according to the work and rest mode of the user while enhancing the identity identifying security of operating the IOT management apparatus by the user are current important issues.

### SUMMARY OF THE INVENTION

In view of the above-mentioned subject, an object of the invention is to provide a smart control apparatus, a smart control system and a smart control method having the high identifying rate and capable of identifying the user's ambient environment and the user's operation behavior concurrently to have the corresponding adjustment.

To achieve the above-identified object, the invention provides a smart control apparatus linking to at least one smart electronic apparatus. The smart control apparatus includes an identifying module, a learning recording module and a control module. The identifying module identifies an identity of at least one user. The learning recording module electrically connected to the identifying module records and learns an operation of the user on at least one smart electronic apparatus and generates a learning result. The control module linking to the learning recording module generates and transmits a control signal according to the learning result to control the smart electronic apparatus.

To achieve the above-identified object, the invention provides a smart control apparatus linking to at least one smart electronic apparatus. The smart control apparatus includes an identifying module, a learning recording module and a control module. The identifying module identifies an identity of at least one user. The learning recording module electrically connected to the identifying module records a time of appearance of the user in a predetermined region to learn a work and rest mode of the user and generate a learning result. The control module linking to the learning recording module generates and transmits a control signal according to the learning result to control the smart electronic apparatus.

To achieve the above-identified object, the invention provides a smart control system linking to at least one smart electronic apparatus. The smart control system includes a management server and a smart control apparatus. The smart control apparatus includes an identifying module, a learning recording module and a control module. The identifying module identifies an identity of at least one user. The learning recording module electrically connected to the identifying module records and learns an operation of the user on at least one smart electronic apparatus and generates a learning result. The control module linking to the learning recording module generates and transmits a control signal according to the learning result to control the smart electronic apparatus.

To achieve the above-identified object, the invention provides a smart control system linking to at least one smart electronic apparatus. The smart control system includes a management server and a smart control apparatus. The smart control apparatus can link to the smart electronic apparatus to obtain an operation of the user using the smart electronic apparatus and the identity information of the user. The management server links to the smart control apparatus and includes an identifying module and a learning module. The identifying module receives the identity information of the user to identify an identity of at least one user. The learning recording module receives the operation of the user using the smart electronic apparatus, and records and learns the operation of the user to generate and transmit a learning result to the smart control apparatus. Thus, the smart control apparatus can generate and transmit a control signal according to the learning result to control the smart electronic apparatus.

To achieve the above-identified object, the invention provides a smart control system linking to at least one smart electronic apparatus. The smart control system includes a management server and a smart control apparatus. The smart control apparatus includes an identifying module, a learning recording module and a control module. The identifying module identifies an identity of at least one user. The learning recording module electrically connected to the identifying module records a time of appearance of the user in a predetermined region to learn a work and rest mode of the user and generates a learning result. The control module linking to the learning recording module generates and transmits a control signal according to the learning result to control the smart electronic apparatus.

To achieve the above-identified object, the invention provides a smart control system linking to at least one smart electronic apparatus. The smart control system includes a management server and a smart control apparatus. The smart control apparatus records a time of appearance of the user in a predetermined region to generate a record data and obtain the identity information of the user. The management server links to the smart control apparatus and includes an identifying module and a learning recording module. The identifying module receives the identity information of the user to identify an identity of at least one user. The learning recording module receives the record data, learns a work time and a rest time of the user and generates and transmits a learning result to the control apparatus. The smart control apparatus generates and transmits a control signal according to the learning result to control the smart electronic apparatus.

To achieve the above-identified object, the invention provides a storage medium storing an application program adapted to and installed in a host linking to at least a smart electronic apparatus. The application program executes at least the following steps of: identifying an identity of at least one user; recording and learning an operation of the user on the smart electronic apparatus and generating a learning result; and making the host generate and transmit a control signal according to the learning result to control the smart electronic apparatus.

To achieve the above-identified object, the invention provides a storage medium storing an application program adapted to and installed in a host linking to at least a smart electronic apparatus. The application program executes at least the following steps of: identifying an identity of at least one user; recording a time of appearance of the user in a predetermined region to learn a work and rest mode of the user and generating a learning result; and making the host generate and transmit a control signal according to the learning result to control the smart electronic apparatus.

In one embodiment, the identifying module is a face identifying module, an iris identifying module, a fingerprint identifying module, a voice identifying module or a gesture identifying module.

In one embodiment, the identifying module includes an image extracting module for extracting at least two image data. The smart control apparatus further includes an identifying module linking to the image extracting module, obtaining a behavior data of the user and an appearance data of at least one static object according to the at least two image data, and obtaining an environment data according to the appearance data of the at least one static object.

In one embodiment, the control module obtains an event data according to the behavior data and the environment data, and generates and transmits a control signal to the at least one smart electronic apparatus according to the event data.

In one embodiment, the identifying module includes a motion identifying unit and an environment identifying unit. The motion identifying unit obtains the behavior data according to a motion of the user. The environment identifying unit identifies at least one static object according to the appearance data, and obtains the environment data according to the identified at least one static object.

In one embodiment, the environment identifying unit receives a feedback signal from at least one smart electronic apparatus, and updates the identified at least one static object according to the feedback signal.

In one embodiment, the feedback signal includes an identification data of the at least one smart electronic apparatus, and the environment identifying unit updates the identified at least one static object according to the identification data.

In one embodiment, the environment identifying unit obtains a relative distance data regarding the at least one smart electronic apparatus according to an intensity of the feedback signal, and updates the identified at least one static object according to the relative distance data.

In one embodiment, the motion identifying unit receives a feedback signal from the at least one smart electronic apparatus, and updates the behavior data according to the feedback signal.

In one embodiment, the smart control apparatus further includes a communication module. The communication module links to a communication network, and transmits the image data, extracted by the image extracting module, to a far-end apparatus, for responding to a real-time watch demand of a far-end host.

In one embodiment, the image data coming from the image extracting module is transmitted to the user directly by the smart control apparatus.

In one embodiment, the smart control apparatus further includes a storage unit. The storage unit electrically connected to the learning recording module stores a record data generated by the learning recording module, and stores the image data extracted by the image extracting module.

In one embodiment, the storage unit is a hard disk, a solid state disk, an optical storage medium, a flash memory, a USB disk, an eMMC storage unit, or a combination thereof.

In one embodiment, the communication network is 3G, LTE, WiMAX, Internet network, Wi-Fi network, Bluetooth, Near Field Communication (NFC), ZigBee, Z-Wave, Infrared (IR), or Radio Frequency (RF).

In one embodiment, the far-end host is a smart phone, a pad computer, a tablet, a notebook computer, a desktop computer or a pocket computer.

In one embodiment, the smart electronic apparatus includes a light, an air conditioner, a TV, a camera, a thermostat, a door apparatus or a door lock.

In one embodiment, the operation includes adjusting the temperature, switching a TV channel, turning on/off a light, adjusting the thermostat, adjusting the air conditioner, using a refrigerator, locking/unlocking the door lock.

In one embodiment, the user manually operates the smart electronic apparatus.

In one embodiment, the record data generated by the learning recording module records the data of the user of manually operating the smart electronic apparatus.

In one embodiment, the user operates the smart electronic apparatus through the far-end apparatus.

In one embodiment, the user operates the smart electronic apparatus through another smart electronic apparatus.

In one embodiment, the smart control apparatus further includes a processor or a processing chip including the learning recording module and the control module.

In one embodiment, the learning recording module further learns the operation of the smart control apparatus on the smart electronic apparatus.

In one embodiment, the smart control apparatus further includes a plurality of sensors electrically connected to the control module. The control module controls the sensors according to the learning result.

In one embodiment, the sensor includes an image sensor, a motion sensor, a light sensor, an environment sensor, a voice sensor, a gas sensor, or an ambient sensor.

In one embodiment, the control module transmits information to the user to notice the user to check, repair, maintain or clean the smart electronic apparatus.

In one embodiment, the work and rest mode includes the time when the user gets up, the time when the user goes outside, the time when the user comes back home, the time when the user goes to sleep, the TV channel chosen by the user, the dinner time of the user, the shower time of the user, the laundry time of the user, the dressing time of the user, the study time of the user, the clean time of the user, the chatting time of the user, the time when the user uses the artifact, or the reading time of the user.

In one embodiment, when the learning recording module records the time of the user appearing outside of a room in the morning, the time is recorded as the time when the user gets up.

In one embodiment, the smart control system further includes a third-party apparatus linking to the management server to provide a service, and the management server pushes the service from the third-party apparatus to the user according to the learning result.

In one embodiment, the service includes selling a product, selling a ticket, checking or repairing a smart electronic apparatus, broadcasting an advertisement, home care, logistics distribution or the like.

In one embodiment, the management server pushes the service from the third-party apparatus to a smart phone, a pad computer, a tablet, a notebook computer, a desktop computer or a pocket computer of the user.

In one embodiment, the smart control apparatus includes a plurality of sensors for extracting an event information.

In one embodiment, the smart control apparatus uploads and stores the event data to the management server.

In one embodiment, the management server transmits a stream of the image, saved on the management server, to the user as receiving a backtracking watching demand.

In one embodiment, the management server transmits a stream of the image saved on the management server to a smart phone, a pad computer, a tablet, a notebook computer, a desktop computer or a pocket computer of the user.

In one embodiment, the management server includes a collecting module and a power saving and analyzing module. The collecting module collects operations on other smart electronic apparatuses of other users in a predetermined range and generates a collecting data. The power saving and analyzing module electrically connected to the collecting module analyzes the collecting data generated by the collecting module to generate a power saving information. The power saving information is transmitted to the smart control apparatus. Thus, the smart control apparatus can control the smart electronic apparatus through the power saving information.

In one embodiment, the learning recording module records an operation of the user on the smart electronic apparatus in a record data, which is uploaded from the smart control apparatus to the management server.

In one embodiment, the host is a smart phone, a pad computer, a tablet, a notebook computer, a desktop computer or a pocket computer.

In summary, in the smart control apparatus of the invention, the identifying module of the smart control apparatus can identify the identity of at least one user. The learning recording module records and learns an operation of the user on at least one smart electronic apparatus and generates a learning result, or records a time of appearance of the user in a predetermined region to learn a work and rest mode of the user and generate another learning result. The control module further generates and transmits a control signal to the smart electronic apparatus according to the learning result generated by the learning recording module. Thus, the smart control apparatus can perform different control methods according to the user's identity, the behavior of the user of operating the smart electronic apparatus, the different times of the work and rest mode that the user appears in the predetermined region, and the ambient environment. Thus, the human-oriented service dedicated for the user's operation behavior and habit can be provided. In addition, the smart electronic apparatus has the corresponding operation function according to the environment and condition thereof. The invention solves the problems of the conventional smart control apparatus and smart electronic apparatus (IOT management apparatus) that the smart electronic apparatus (IOT management apparatus) cannot have the corresponding different operations according to the user's work and rest time, that the identity identifying security cannot be enhanced when the user is operating the smart electronic apparatus (IOT management apparatus), and that the control method cannot be changed according to both the identifying of the condition of the ambient environment and the user's operation behavior.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a functional block diagram showing a smart control apparatus according to a preferred embodiment of the invention.

FIG. 2A is a detailed functional block diagram showing an identifying module according to the preferred embodiment of the invention.

FIG. 2B is a functional block diagram showing the identifying module according to the preferred embodiment of the invention.

FIG. 3A is a functional block diagram showing a smart control apparatus having the identifying module according to the preferred embodiment of the invention.

FIG. 3B is another functional block diagram showing the identifying module according to the preferred embodiment of the invention.

FIG. 4A is a functional block diagram showing a smart control apparatus according to another preferred embodiment of the invention.

FIG. 4B is a schematic view showing a work and rest mode according to another preferred embodiment of the invention.

FIG. 5A is a schematic view showing a smart control system according to another preferred embodiment of the invention.

FIG. 5B is a schematic view showing a smart control system according to another preferred embodiment of the invention.

FIG. 6A is a schematic view showing a smart control system according to another preferred embodiment of the invention.

FIG. 6B is a schematic view showing a smart control system according to another preferred embodiment of the invention.

FIG. 7A is a functional block diagram showing a storage medium according to another preferred embodiment of the invention.

FIG. 7B is a functional block diagram showing a storage medium according to still another preferred embodiment of the invention.

FIG. 8A is a flow chart showing executing steps of an application program according to another preferred embodiment of the invention.

FIG. 8B is a flow chart showing executing steps of an application program according to still another preferred embodiment of the invention.

### DETAILED DESCRIPTION OF THE INVENTION

The present invention will be apparent from the following detailed description, which proceeds with reference to the accompanying drawings, wherein the same references relate to the same elements.

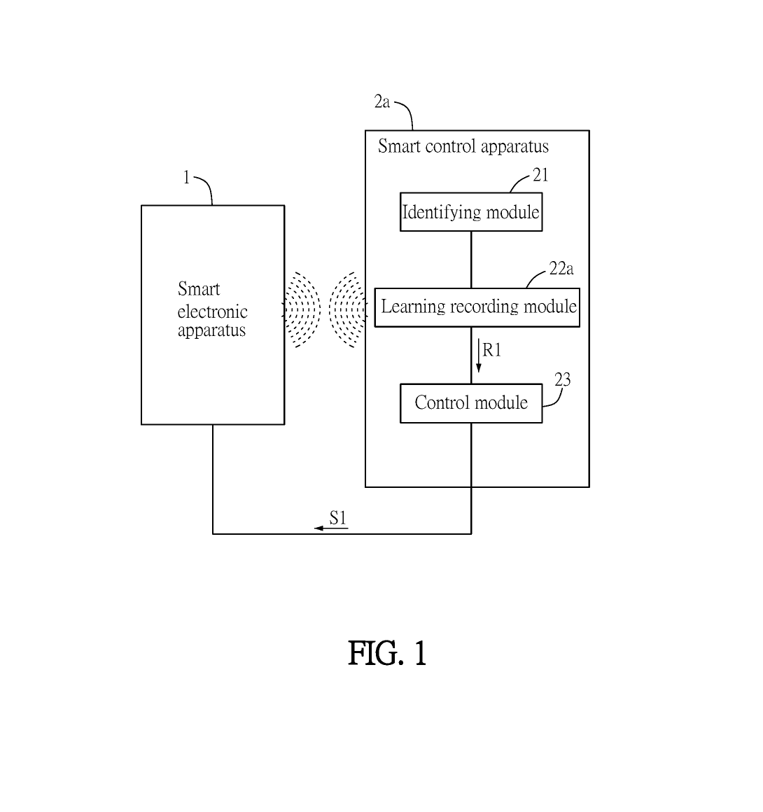

FIG. 1 is a functional block diagram showing a smart control apparatus 2a according to a preferred embodiment of the invention. Referring to FIG. 1, the smart control apparatus 2a links to at least one smart electronic apparatus 1. Although this embodiment is described with reference to the example, in which the smart control apparatus 2a links to the smart electronic apparatus 1, the invention is not restricted thereto. The smart control apparatus 2a includes an identifying module 21, a learning recording module 22a and a control module 23.

The smart electronic apparatus 1 may be, for example but without limitation to, a light, an air conditioner, a TV, a camera, a thermostat, a door apparatus, a door lock, or other electronic apparatuses frequently used in the home life. The smart control apparatus 2a may be, for example, a control host, which has a photographing lens, and can be applied in conjunction with a smart phone, a pad computer, a tablet, a notebook computer, a desktop computer, a pocket computer or the like. The smart electronic apparatus 1 and the smart control apparatus 2a may link to each other through various communication technologies, such as 3G, 4G LTE, WiMAX, Internet network, Wi-Fi network, Bluetooth, Near Field Communication (NFC), ZigBee, Z-Wave, Infrared (IR), Radio Frequency (RF) or the like, and the invention is not restricted thereto.

In this embodiment, the identifying module 21 can identify an identity I of at least one user U, and may be a face identifying module, an iris identifying module, a fingerprint identifying module, a voice identifying module, a gesture identifying module or the like. The identifying module 21 may be a combination of identifying modules with different biometrics characteristic identifying functions, and the invention is not restricted thereto. Thus, the identifying module 21 can achieve the function of precisely identifying the user's identity I according to the user's biometrics characteristic.

The learning recording module 22a electrically connected to the identifying module 21 records and learns the operation of the user U on the at least one smart electronic apparatus 1, and generates a learning result R1. The operation of the user U may be the behavior of the user, who often manually operates the smart electronic apparatus 1, such as adjusting the temperature, switching a TV channel, turning on/off the light, adjusting the thermostat, adjusting the air conditioner, using a refrigerator, locking/unlocking the door lock, or the like. Meanwhile, the learning result R1 generated by the learning recording module 22a records, in detail, the specific characteristics when the user manually operates the smart electronic apparatus.

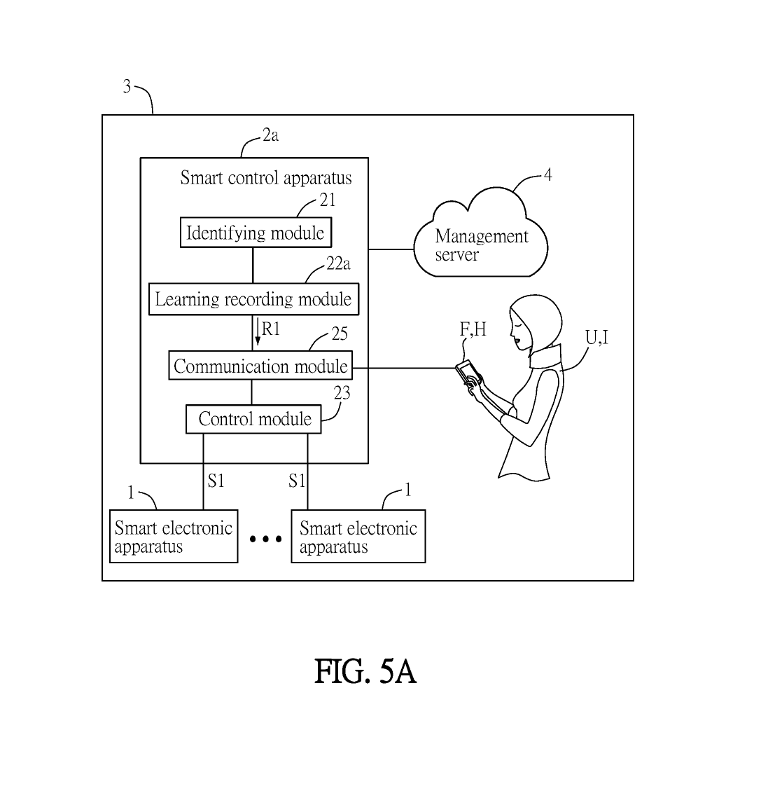

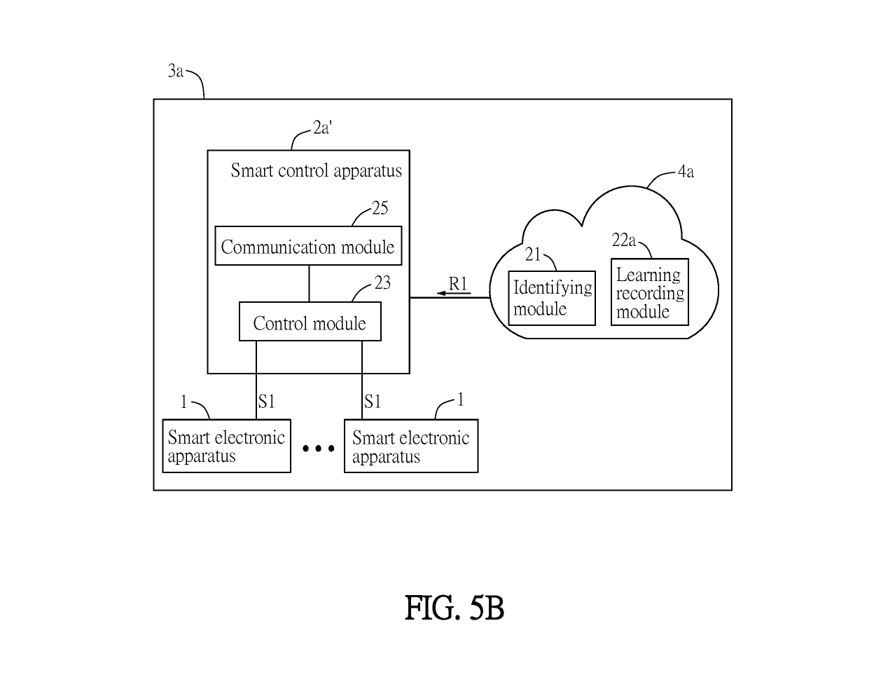

Furthermore, in addition to the direct manual operating of the smart electronic apparatus 1 in this embodiment, the user U can further remotely operate the smart electronic apparatus 1 (see FIG. 5A) through a far-end apparatus F, or the user U can use another smart electronic apparatus to operate the smart electronic apparatus 1. Therefore, in addition to the learning of the operation of the user U on the at least one smart electronic apparatus 1, the learning recording module 22a can further learn the operation of the smart control apparatus 2a on the smart electronic apparatus 1, or the operation of another smart electronic apparatus on the smart electronic apparatus 1. Thus, the learning recording module 22a can have the very sufficient learning source, which can cover various operations to generate a more detailed learning result R1.

The control module 23 linking to the learning recording module 22a may include at least one processing unit and a memory cell (not shown), or include other control hardware, software, or firmware. The memory cell stores one or multiple program instructions. When the processing unit accesses and executes the program instructions, the control module 23 can generate and transmit a control signal S1 to the smart electronic apparatus 1 using the built-in processing unit and memory cell according to the learning result R1 generated by the learning recording module 22a. In addition, the control module 23 can further transmit the information to the user U to notice the user to check, repair, maintain or clean the smart electronic apparatus 1.

In this embodiment, the smart control apparatus 2a can further include a plurality of sensors (not shown). The sensor may include an image sensor, a motion sensor, a light sensor, an environment sensor, a voice sensor, a gas sensor, an ambient sensor, or a combination of different types of sensors. The sensors are electrically connected to the control module 23. The control module 23 controls the sensors according to the learning result R1, so that the sensors of the smart control apparatus 2a have the advanced smart sensing functions.

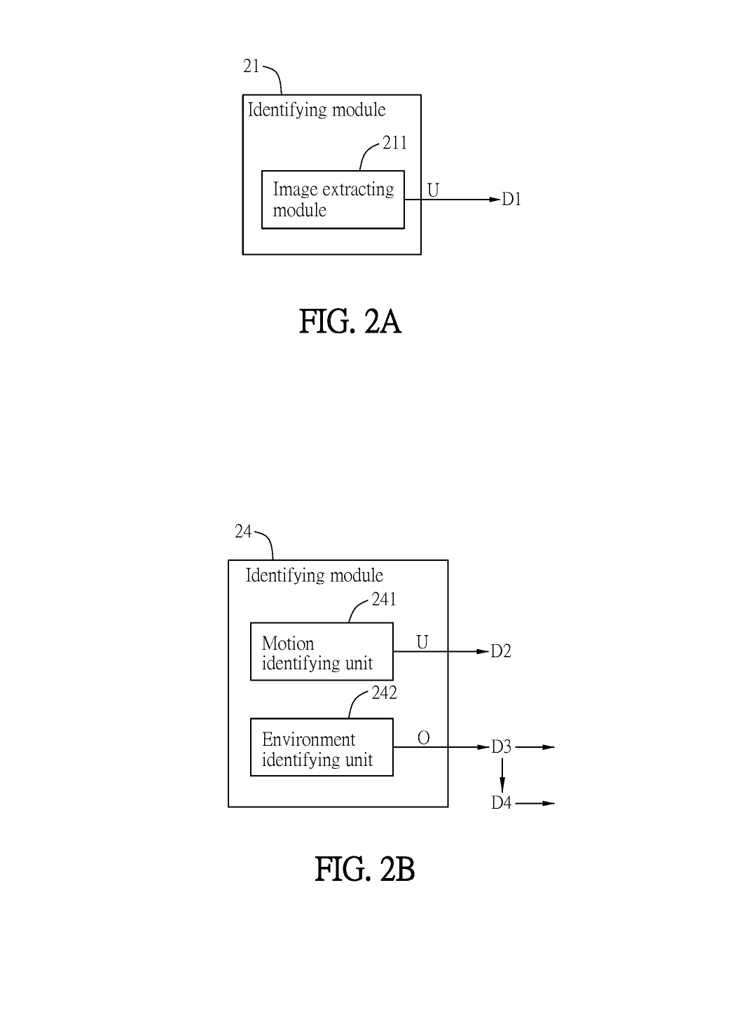

FIG. 2A is a detailed functional block diagram showing the identifying module 21 according to the preferred embodiment of the invention. Referring to FIG. 2A, the identifying module 21 may further include an image extracting module 211, which may be a camera or a photographing lens built in the smart control apparatus 2a. When being applied in conjunction with the smart phone, the pad computer or the notebook computer, the image extracting module 211 may be the photographing lens of the smart phone, the pad computer or the notebook computer. The image extracting module 211 further extracts multiple image data D1, and the image data D1 of the image extracting module 211 can be directly transmitted to the user U from the smart control apparatus 2a. In addition, as shown in FIG. 2B, the smart control apparatus 2a further includes an identifying module 24 for identifying the image data D1.

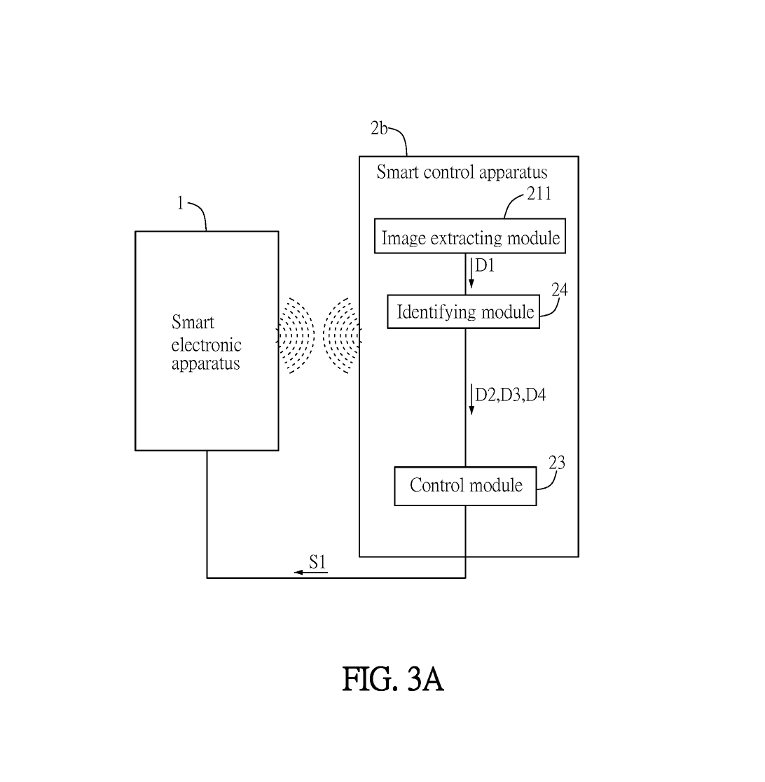

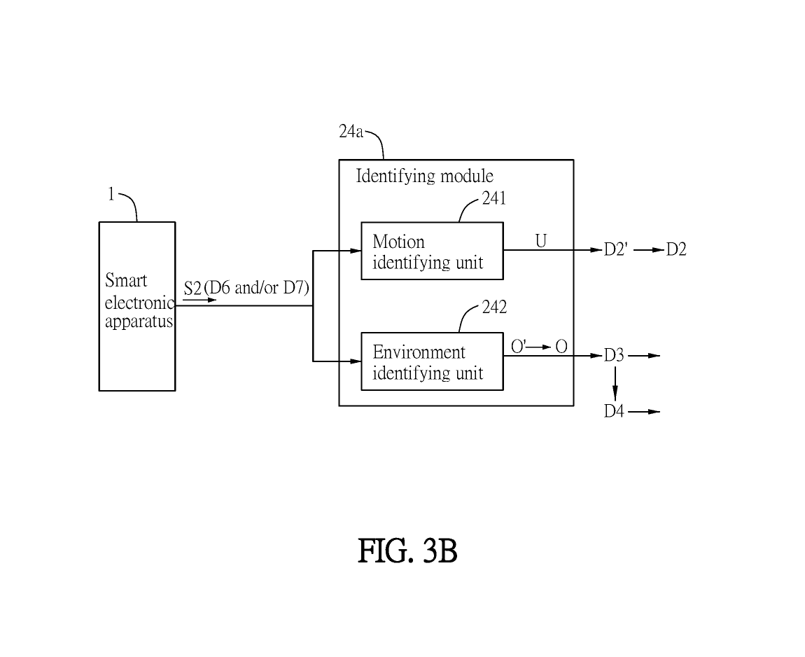

FIG. 3A is a functional block diagram showing a smart control apparatus 2b having an identifying module according to the preferred embodiment of the invention. Referring to FIG. 3A, the identifying module 24 links to the image extracting module 211. Specifically, the identifying module 24 may be an image identifying module, which can identify the ambient environment characteristics of the user U and the behavior motion and other characteristics of the user U through the algorithm. In this embodiment, the identifying module 24 obtains the behavior data D2 of the user U and an appearance data D3 of at least one static object O (shown in FIG. 2B) according to the at least two image data D1 extracted by the image extracting module 211, and obtains an environment data D4 according to the appearance data D3 of the at least one static object O. The static object O may be, for example, the sofa, table, chair, coffee machine, TV, speaker, lamp, or another frequently seen electronic home apparatus or appliance.

In this embodiment, the smart control apparatus 2b may further include a storage unit, and a processor or processing chip (not shown). The storage unit may be, for example, a hard disk, a solid state disk, an optical storage medium, a flash memory, a USB disk or an eMMC storage unit. The storage unit electrically connected to the learning recording module 22a stores the learning result R1 generated by the learning recording module 22a, and stores the image data D1 extracted by the image extracting module 211. The processor or processing chip includes a learning recording module and a control module. The learning recording module 22a and the control module 23 are integrated using the processor or processing chip, so that the smart control apparatus 2b can further achieve the component integrated, thinned and lighted effects.

The smart control apparatus 2b can further include a communication module (e.g., the symbol 25 in FIG. 5A). The communication module links to the communication network, and can transmit the image data D1, extracted by the image extracting module 211, to the far-end apparatus F, for responding a real-time watch demand of the far-end host H (see FIG. 5A). In the example of FIG. 5A, the far-end apparatus F and the far-end host H pertain to the same apparatus, and the far-end host H may be the smart phone, pad computer, tablet, notebook computer, desktop computer, or pocket computer. The communication module 25 further has the function of transmitting the at least two image data D1, extracted by the image extracting module 211, to other management servers.

FIG. 2B is a functional block diagram showing the identifying module 24 according to the preferred embodiment of the invention. Referring to FIG. 2B, the identifying module 24 specifically includes a motion identifying unit 241 and an environment identifying unit 242. The motion identifying unit 241 obtains the behavior data D2 according to the motion of the user U. The environment identifying unit 242 identifies the at least one static object O according to the appearance data D3, and obtains the environment data D4 according to the identified at least one static object O. For example, when a smart control system 3a identifies that a young lady manipulates the remote controller to turn on the TV by her right hand on the sofa in the living room at ten o'clock p.m., the behavior data D2 represents the behavior that the young lady uses her right hand to manipulate the remote controller to turn on the TV. More particularly, the behavior data D2 can further include the user's identity data (young lady) and/or time information (ten o'clock p.m.), and the appearance data D3 indicate several static objects O (sofa, TV and the like) in the living room, so that the environment of the user is identified as being located in the living room accordingly the appearance data D3 and the environment data D4.

Referring to FIG. 3A, the control module 23 links to the identifying module 24, and may include at least one processing unit and a memory cell (not shown), or include other control hardware, software or firmware. The memory cell stores one or multiple program instructions. When the processing unit accesses and executes these program instructions, the control module 23 obtains an event data D5 using the built-in processing unit and memory cell according to the behavior data D2 and the environment data D4, and the smart control apparatus 2b generates and transmits a control signal S1 to the smart electronic apparatus 1 according to the event data D5.

In the above-mentioned embodiment, the control module 23 obtains the event data D5 (turning on the TV at ten o'clock p.m.) according to the behavior data D2 (the behavior of the young lady of turning on the TV) and the environment data D4 (in the living room at ten o'clock p.m.), and the smart control apparatus 2b generates and transmits the control signal S1 (automatically turning on the TV at ten o'clock p.m.) to the smart electronic apparatus 1 (TV) according to the event data D5 (turning on the TV at ten o'clock p.m.), so that the smart electronic apparatus 1 (TV) is turned on automatically.

FIG. 3B is another functional block diagram showing an identifying module 24a according to the preferred embodiment of the invention. Referring to FIG. 3B, the environment identifying unit 242 receives a feedback signal S2 from the at least one smart electronic apparatus 1, and updates the identified at least one static object O according to the feedback signal S2. For example, the environment identifying unit 242 of the identifying module 24a originally judges the appearance data D3 of the static object O at the position of the TV as a painting but not a TV. At this time, the smart electronic apparatus 1 (e.g., the TV) transmits the feedback signal S2 to the environment identifying unit 242, so that the appearance data D3 of the static object O′, originally incorrectly judged by the environment identifying unit 242, can be updated to that of the correct static object O. Herein, the originally incorrectly judged painting is updated to the TV, which is identified according to the image of the static object O, according to the feedback signal S2 transmitted from the TV.

The feedback signal S2 includes an identification data D6 of the at least one smart electronic apparatus 1, and the environment identifying unit 242 updates the identified at least one static object O according to the identification data D6. The identification data D6 may be, for example, the name, brand, model, size or coloring of electronic apparatus or the like, and is advantageous to serving as the reference for the environment identifying unit 242 to correctly identify the static object O. Similar to the above-mentioned example, if the identification data D6 represents a SONY 55-inch silver LCD TV, the information included in the identification data D6 is returned to the environment identifying unit 242 through the feedback signal S2. Thus, if the static object O′ originally identified by the environment identifying unit 242 is not a LCD TV according to the appearance data D3, then the identified static object O will be updated to the LCD TV.

In addition, the environment identifying unit 242 may further obtain a relative distance data D7 relating to the at least one smart electronic apparatus 1 according to the intensity of the feedback signal S2, and update the identified at least one static object O according to the relative distance data D7. For example, the user U has a LCD TV in the living room and a coffee machine in the kitchen. At this time, because the location of the LCD TV in the living room is nearer to the location of the smart control apparatus 2a in the living room, the feedback signal S2 of the LCD TV is stronger that the feedback signal S2 of the coffee machine in the kitchen. Thus, the environment identifying unit 242 can obtain the relative distance data D7 according to the intensity of the feedback signal S2 to correctly identify the static object O as the LCD TV but not the coffee machine.

Furthermore, the motion identifying unit 241 may also receive the feedback signal S2 from the at least one smart electronic apparatus 1, and update the behavior data D2 according to the feedback signal S2. Similar to the behavior of the lady of turning on the TV, if the identifying module 24a cannot correctly judge that the behavior of the lady in the image frame is to turn on the TV (that is, the motion identifying unit 241 generates the behavior data D2′ that is incorrect or has an error) according to the image data D1, then the feedback signal S2 of the smart electronic apparatus 1 (e.g., the TV) is fed back to the motion identifying unit 241, so that the behavior data D2′ judged by the motion identifying unit 241 is updated to the correct behavior data D2. That is, the motion identifying unit 241 can correctly judge that the behavior of the lady in the frame is to turn on the TV.

There are three features to be emphasized. The first feature is that the identifying module 21 of this embodiment can precisely identify the identity I of at least one user according to the user's characteristics. The second feature is that the learning recording module 22a may further learn the operation of the smart control apparatus 2a on the smart electronic apparatus 1, or the operation of another smart electronic apparatus on the smart electronic apparatus 1 in addition to the learning of the operation of the user U on the at least one smart electronic apparatus 1. Thus, the learning recording module 22a has the very sufficient learning source, which can cover various operations to generate the detailed learning result R1. Regarding the third feature, when the motion identifying unit 241 and the environment identifying unit 242 cannot generate the correctly judged data (i.e., when the behavior data D2 and the environment data D4 have errors), the feedback signal S2 coming from the smart electronic apparatus 1 can be received, and the identified behavior data D2 and the static object O can be updated according to the feedback signal S2, so that the identifying rate and accuracy of the identifying module 24a can be enhanced.

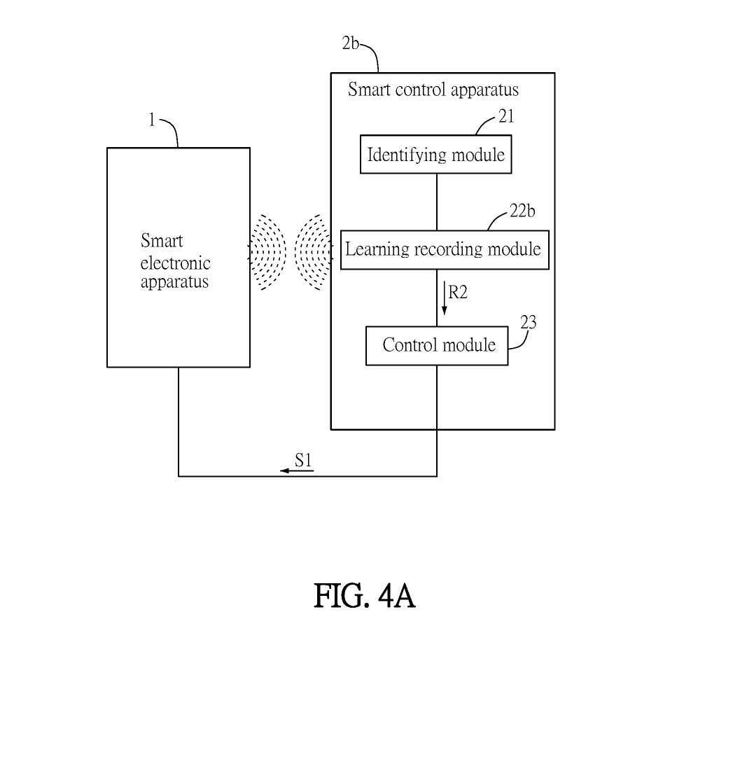

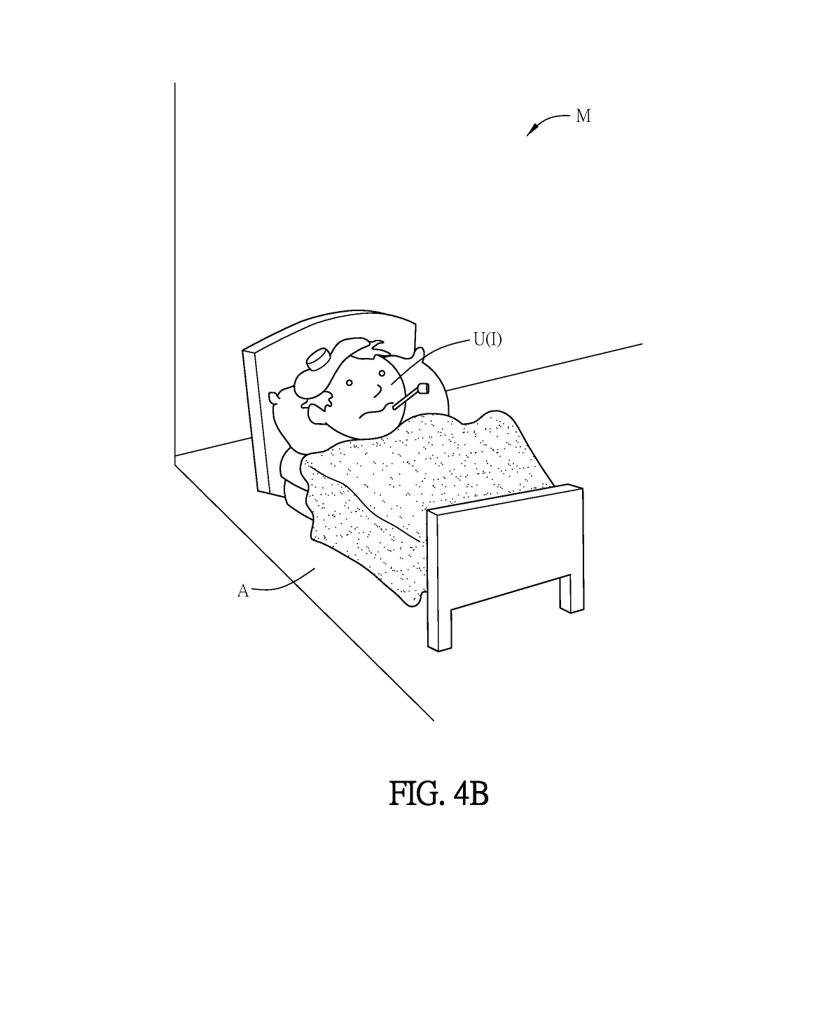

FIG. 4A is a functional block diagram showing a smart control apparatus 2b according to another preferred embodiment of the invention. Referring to FIG. 4A, the smart control apparatus 2b similarly links to at least one smart electronic apparatus 1. The smart control apparatus 2b similarly includes the identifying module 21, a learning recording module 22b and the control module 23, and is different from the smart control apparatus 2a of the preferred embodiment in that the learning recording module 22b of the smart control apparatus 2b does not record and learn the operation of the user U on the at least one smart electronic apparatus 1 and generate the learning result R1. Instead, the learning recording module 22b additionally records the time of appearance of the user U in a predetermined region A to learn a work and rest mode M of the user U and generate a learning result R2.

FIG. 4B is a schematic view showing a work and rest mode according to another preferred embodiment of the invention. Referring to FIG. 4B, the predetermined region A may be at a specific location, such as the living room, kitchen, doorway, bedroom, study room and the like at the home of the user U, and the work and rest mode M may include the time when the user U gets up, the time when the user goes outside, the time when the user comes back home, the time when the user goes to sleep, the TV channel chosen by the user, the dinner time of the user, the shower time of the user, the laundry time of the user, the dressing time of the user, the study time of the user, the clean time of the user, the chatting time of the user, the time when the user uses the artifact, the reading time or the like. For example, when the learning recording module 22b records the time of the user U appearing outside of a room in the morning, then the time is recorded by the learning recording module 22b as the time when the user U gets up. Alternatively, when the learning recording module 22b records the time when the user U enters the bedroom at night, the time is recorded by the learning recording module 22b as the time when the user U goes to sleep.

Therefore, the smart control apparatus 2b can learn and record the time when the user U appears in the predetermined region A through the learning recording module 22b to learn the work and rest mode M of the user U, and generate the learning result R2 to the control module 23 to generate and transmit the control signal S1 to the smart electronic apparatus 1. According to the work and rest mode M generated according to the time when the user U appears in the predetermined region A, the smart control apparatus 2b can control the smart electronic apparatus 1 in a more human-oriented and smart manner.

FIG. 5A is a schematic view showing a smart control system 3 according to another preferred embodiment of the invention. Referring to FIG. 5A, the smart control system 3 includes at least one smart electronic apparatus 1, a smart control apparatus 2a and a management server 4. The smart control apparatus 2a links to the at least one smart electronic apparatus 1. In the example of this embodiment, two smart electronic apparatuses 1 link to the smart control apparatus 2a. However, the number of the smart electronic apparatuses 1 linking to the smart control apparatuses 2a is not restricted thereto.

The smart control apparatus 2a includes the identifying module 21, the learning recording module 22a and the control module 23, and further includes the communication module 25. The communication module 25 has the function of transmitting the information generated by the identifying module 21 and the learning recording module 22a to the management server 4. The learning recording module 22a is similarly electrically connected to the identifying module 21 and records and learns the operation of the user U on the at least one smart electronic apparatus 1 and generates a learning result R1. The control module 23 linking to the learning recording module 22a generates the control signal S1 according to the learning result R1 to control the smart electronic apparatus 1. In addition, the smart control apparatus 2a links to the management server 4 by the communication module 25, and can upload the identification data of at least one user identity I, identified by the identifying module 21, and the learning result R1 generated by the learning recording module 22a, to the management server 4 through the communication module 25, to serve as the resource of the management server 4 for other analyses or utilizations. For example, the suggestions or indications for operating the smart electronic apparatus 1 can be provided to different users.

The connection relationships, functions and effects relating to the identifying module 21, the learning recording module 22a and the control module 23 in the smart control apparatus 2a have been described hereinabove, and detailed descriptions thereof will be omitted. In addition, it is worth mentioning that the smart control system may further include a third-party apparatus (not shown) connected to the management server 4 to provide a service. The management server 4 pushes the service from the third-party apparatus to the user according to the learning result R1, wherein the service may include the utility function of selling a product, selling a ticket, checking or repairing a smart electronic apparatus, or broadcasting an advertisement, home care, logistics distribution or the like, and the management server 4 can push the service from the third-party apparatus to the smart phone, pad computer, tablet, notebook computer, desktop computer or pocket computer of the user U.

In addition, the smart control apparatus 2a may further include a plurality of sensors for extracting the event information, which is uploaded and saved to the management server 4 through the smart control apparatus. In addition, the management server 4 can further transmit a stream of the image, saved in the management server 4, to the user U as receiving a backtracking watching demand of the user U. Similarly, the management server 4 can transmit a stream of the image to the smart phone, pad computer, tablet, notebook computer, desktop computer or pocket computer of the user.

In addition, the smart control apparatus 2a including the sensor may further include a collecting module and a power saving and analyzing module (not shown). The collecting module collects operations of other users on other smart electronic apparatuses in the predetermined range, and generates a collecting data. The power saving and analyzing module electrically connected to the collecting module analyzes the collecting data generated by the collecting module to generate a power saving information. The power saving information is transmitted to the smart control apparatus 2a, so the smart control apparatus 2a can control the smart electronic apparatus 1 according to the power saving information.

FIG. 5B is a schematic view showing a smart control system 3a according to another preferred embodiment of the invention. Referring to FIG. 5B, the smart control system 3a similarly includes at least one smart electronic apparatus 1, a smart control apparatus 2a′ and a management server 4a. The differences between the smart control apparatus 2a′ and the smart control apparatus 2a, and the management server 4a and the management server 4 reside in that the identifying module 21 may not be disposed inside the smart control apparatus 2a′, and that the learning recording module 22a also may not be disposed inside the smart control apparatus 2a′, and may be disposed in the management server 4a.

The smart control apparatus 2a′ can link to the smart electronic apparatus 1 to obtain the operation of the user U of using the smart electronic apparatus 1 and the identity information of the user. In other words, the management server 4a includes the identifying module 21 and further includes the learning recording module 22a. In this case, the management server 4a may be provided with the identifying module 21 and the learning recording module 22a concurrently. The identifying module 21 receives the identity information of the user U to identify the identity I of at least one user. The learning recording module 22a receives the operation of the user U of using the smart electronic apparatus 1, and records and learns the operation of the user U, and thus can identify the identity I of the user U, record and learn the operation of the user U on the at least one smart electronic apparatus 1, generate a learning result R1 returned to the control module 23 of the smart control apparatus 2a′, and thus transmit the control signal S1 to control different smart electronic apparatuses 1.

In addition, other technical characteristics of the smart control system 3a may be found in the descriptions associated with the smart control system 3, and detailed descriptions thereof will be omitted.

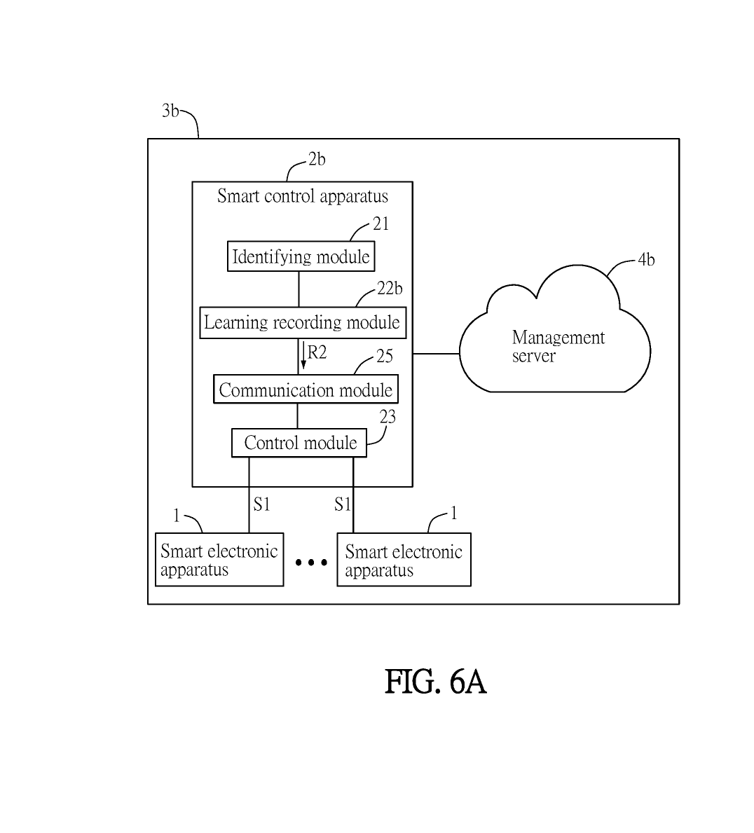

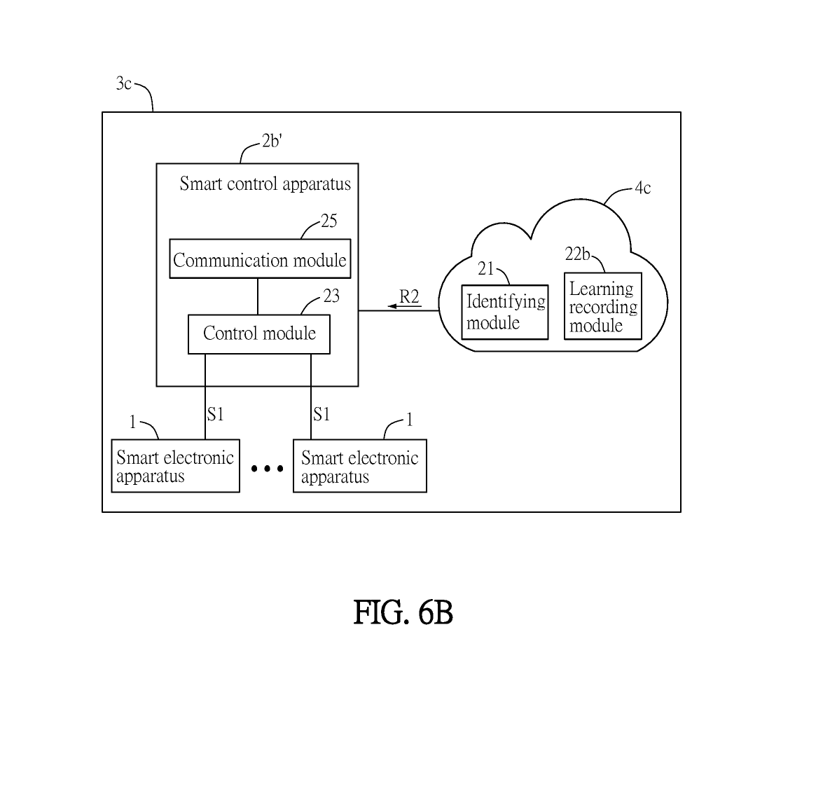

FIG. 6A is a schematic view showing a smart control system 3b according to another preferred embodiment of the invention. Referring to FIG. 6A, the smart control system 3b similarly includes at least one smart electronic apparatus 1, a smart control apparatus 2b and a management server 4b. The smart control apparatus 2b links to the at least one smart electronic apparatus 1. In the example of this embodiment, two smart electronic apparatuses 1 link to the smart control apparatus 2b. However, the number of the smart electronic apparatuses 1 linking to the smart control apparatuses 2b is not restricted thereto.

The smart control apparatus 2b includes the identifying module 21, the learning recording module 22b and the control module 23, and further includes the communication module 25. The communication module 25 has the function of transmitting the information generated by the identifying module 21 and the learning recording module 22b to the management server 4b. What is different from the smart control system 3 is that the learning recording module 22b is electrically connected to the identifying module 21, and records the time of appearance of the user U in the predetermined region A to learn the work and rest mode M of the user U and generate a learning result R2.

The control module 23 linking to the learning recording module 22b generates a control signal S1 according to the learning result R2 to control the smart electronic apparatus 1. In addition, the smart control apparatus 2b links to the management server 4b through the communication module 25, and can upload the identification data, generated by the identifying module 21 after identifying the identity I of the at least one user, and the learning result R2 generated by the learning recording module 22b, to the management server 4b through the communication module 25 to serve as the resource for other analyses of the management server 4b. For example, the resource may make the smart electronic apparatuses 1 of other users obtain the suggestions or indications that is enabled or disabled according to the frequently used work and rest mode of the user at the specific time.

The connection relationships, functions and effects relating to the identifying module 21, the learning recording module 22b and the control module 23 in the smart control apparatus 2b have been described hereinabove, and detailed descriptions thereof will be omitted.

FIG. 6B is a schematic view showing a smart control system 3c according to another preferred embodiment of the invention. Referring to FIG. 6B, the smart control system 3c similarly includes at least one smart electronic apparatus 1, a smart control apparatus 2b′ and a management server 4c. The smart control apparatus 2b′ records the time of appearance of the user U in the predetermined region A to generate a record data and obtain the identity information of the user. The differences between the smart control apparatus 2b′ and the smart control apparatus 2b, and between the management server 4c and the management server 4b will be described in the following. In addition to that the identifying module 21 of the smart control apparatus 2b′ may not be disposed inside the smart control apparatus 2b′, the learning recording module 22b also may not be disposed inside the smart control apparatus 2b′ and may be disposed on the management server 4c.

In other words, the management server 4c includes the identifying module 21 and further includes the learning recording module 22b. In this case, the management server 4c may be provided with the identifying module 21 and the learning recording module 22b concurrently. The identifying module 21 receives the identity information of the user to identify the identity I of at least one user. The learning recording module 22b receives the record data, learns the work rest time of the user U and generates the learning result R2 transmitted to the smart control apparatus 2b′.

Therefore, the management server 4c can identify the identity I of the user U and record the time of appearance of the user U in the predetermined region A to learn the work and rest mode M of the user U, to generate the learning result R2, to return the result to the control module 23 of the smart control apparatus 2b′, and to transmit the control signal S1 to control different smart electronic apparatuses 1.

In addition, other technical characteristics of the smart control system 3c may be referred to the descriptions associated with the smart control system 3b, and detailed descriptions thereof will be omitted.

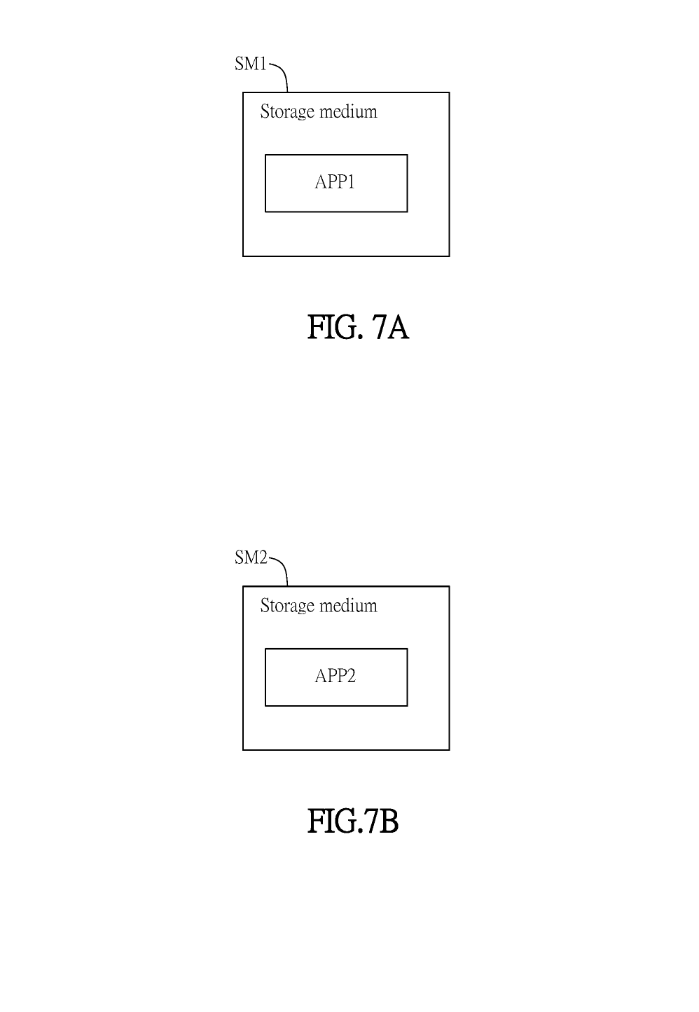

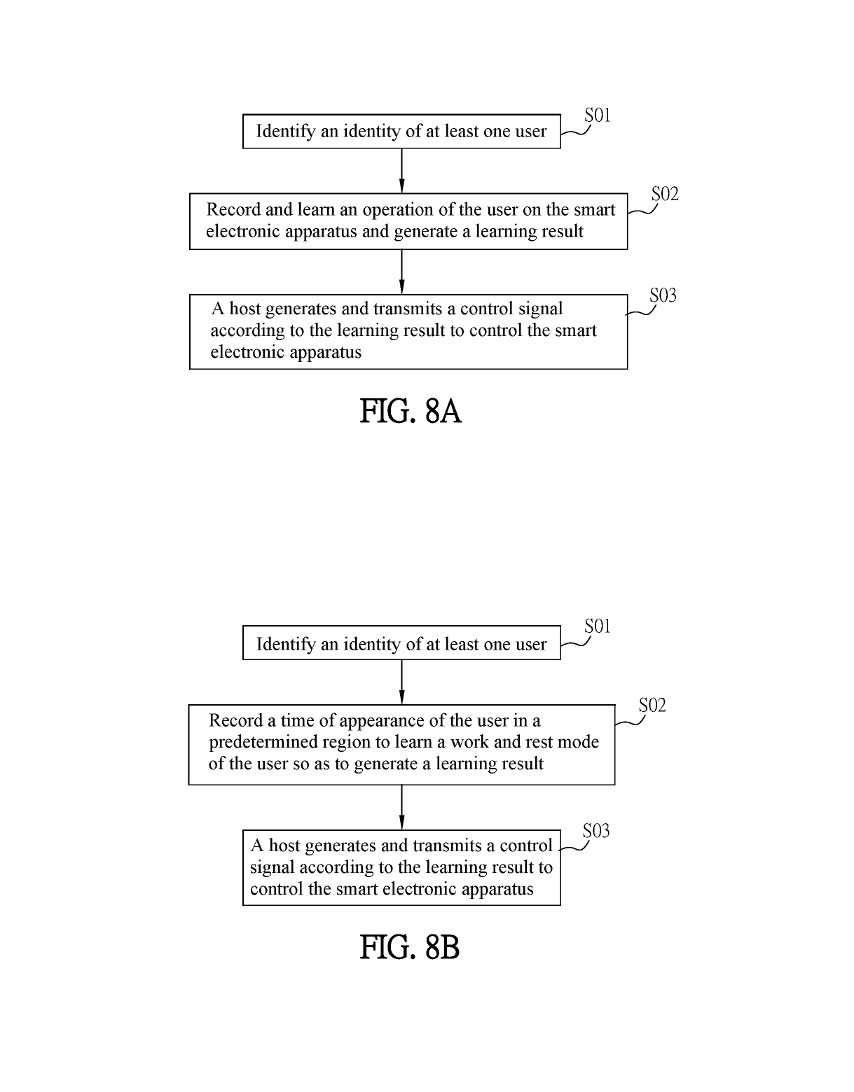

In addition, the invention further provides a storage medium SM1. FIG. 7A is a functional block diagram showing the storage medium SM1 according to another preferred embodiment of the invention. Referring to FIG. 7A, the storage medium SM1 stores an application program APP1 adapted to and installed in a host (not shown) linking to at least one smart electronic apparatus 1. The executing method of the application program APP1 according to the preferred embodiment of the invention will be described with reference to FIGS. 8A and 1. FIG. 8A is a flow chart showing executing steps of an application program according to another preferred embodiment of the invention. The application program executes at least the following steps of: identifying an identity of at least one user (step S01), recording and learning an operation of the user on the smart electronic apparatus and generating a learning result (step S02), so that the host generates and transmits a control signal according to the learning result to control the smart electronic apparatus (step S03).

In addition, the invention further provides another storage medium SM2. FIG. 7B is a functional block diagram showing the storage medium SM2 according to still another preferred embodiment of the invention. Referring to FIG. 7B, the storage medium SM2 similarly stores an application program APP2 adapted to and installed in a host (not shown) linking to at least one smart electronic apparatus 1. The executing method of the application program APP2 according to another preferred embodiment of the invention will be described with reference to FIGS. 8B and 1. FIG. 8B is a flow chart showing executing steps of an application program according to still another preferred embodiment of the invention. The application program executes at least the following steps of: identifying an identity of at least one user (step S01), recording a time of appearance of the user in a predetermined region to learn a work and rest mode of the user and generate a learning result (step S02), so that the host generates and transmits a control signal according to the learning result to control the smart electronic apparatus (step S03).

In addition, other technical characteristics of the control method of the smart control apparatus may be referred to the descriptions associated with the smart control system 3, and detailed descriptions thereof will be omitted.

In summary, in the smart control apparatus of the invention, the identifying module of the smart control apparatus can identify the identity of at least one user. The learning recording module records and learns an operation of the user on at least one smart electronic apparatus and generates a learning result, or records a time of appearance of the user in a predetermined region to learn a work and rest mode of the user and generate another learning result. The control module further generates and transmits a control signal to the smart electronic apparatus according to the learning result generated by the learning recording module. Thus, the smart control apparatus can perform different control methods according to the user's identity, the behavior of the user of operating the smart electronic apparatus, the different times of the work and rest mode that the user appears in the predetermined region, and the ambient environment. Thus, the human-oriented service dedicated for the user's operation behavior and habit can be provided. In addition, the smart electronic apparatus has the corresponding operation function according to the environment and condition thereof. The invention solves the problems of the conventional smart control apparatus and smart electronic apparatus (IOT management apparatus) that the smart electronic apparatus (IOT management apparatus) cannot have the corresponding different operations according to the user's work and rest time, that the identity identifying security cannot be enhanced when the user is operating the smart electronic apparatus (IOT management apparatus), and that the control method cannot be changed according to both the identifying of the condition of the ambient environment and the user's operation behavior.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A smart control apparatus linking to at least one smart electronic apparatus, the smart control apparatus comprising:
an identifying module identifying an identity of at least one user;
a learning recording module, which is electrically connected to the identifying module, and records and learns an operation of the user on the at least one smart electronic apparatus and generates a learning result; and
a control module, which links to the learning recording module, and generates and transmits a control signal according to the learning result to control the smart electronic apparatus.

2. The smart control apparatus according to claim 1, wherein the identifying module is a face identifying module, an iris identifying module, a fingerprint identifying module, a voice identifying module or a gesture identifying module.

3. The smart control apparatus according to claim 1, wherein the identifying module comprises an image extracting module for extracting at least two image data, and the smart control apparatus further comprises an identifying module linking to the image extracting module, obtaining a behavior data of the user and an appearance data of at least one static object according to the at least two image data, and obtaining an environment data according to the appearance data of the at least one static object.

4. The smart control apparatus according to claim 3, wherein the control module obtains an event data according to the behavior data and the environment data, and generates and transmits the control signal to the at least one smart electronic apparatus according to the event data.

5. The smart control apparatus according to claim 4, wherein the identifying module comprises:
a motion identifying unit obtaining the behavior data according to a motion of the user; and
an environment identifying unit identifying the at least one static object according to the appearance data and obtaining the environment data according to the identified at least one static object.

6. The smart control apparatus according to claim 5, wherein the environment identifying unit receives a feedback signal from the at least one smart electronic apparatus, and updates the identified at least one static object according to the feedback signal.

7. The smart control apparatus according to claim 6, wherein the feedback signal comprises an identification data of the at least one smart electronic apparatus, and the environment identifying unit updates the identified at least one static object according to the identification data.

8. The smart control apparatus according to claim 6, wherein the environment identifying unit obtains a relative distance data regarding the at least one smart electronic apparatus according to an intensity of the feedback signal, and updates the identified at least one static object according to the relative distance data.

9. The smart control apparatus according to claim 5, wherein the motion identifying unit receives a feedback signal from the at least one smart electronic apparatus, and updates the behavior data according to the feedback signal.

10. A smart control apparatus linking to at least one smart electronic apparatus, the smart control apparatus comprising:
an identifying module identifying an identity of at least one user;
a learning recording module, which is electrically connected to the identifying module, records a time of appearance of the user in a predetermined region to learn a work and rest mode of the user and generates a learning result; and
a control module linking to the learning recording module and generating and transmitting a control signal according to the learning result to control the smart electronic apparatus.

11. A smart control system linking to at least one smart electronic apparatus, the smart control system comprising:
a management server; and
a smart control apparatus linking to the management server and comprising:
an identifying module identifying an identity of at least one user;
a learning recording module, which is electrically connected to the identifying module, records and learns an operation of the user on the at least one smart electronic apparatus and generates a learning result; and
a control module linking to the learning recording module, and generating and transmitting a control signal according to the learning result to control the smart electronic apparatus.

12. The smart control system according to claim 11, wherein the identifying module is a face identifying module, an iris identifying module, a fingerprint identifying module, a voice identifying module or a gesture identifying module.

13. The smart control system according to claim 11, wherein the identifying module comprises an image extracting module for extracting at least two image data, and the smart control apparatus further comprises an identifying module linking to the image extracting module, obtaining a behavior data of the user and an appearance data of at least one static object according to the at least two image data, and obtaining an environment data according to the appearance data of the at least one static object.

14. The smart control system according to claim 13, wherein the control module obtains an event data according to the behavior data and the environment data, and generates and transmits a control signal to the at least one smart electronic apparatus according to the event data.

15. The smart control system according to claim 14, wherein the identifying module comprises:
a motion identifying unit obtaining the behavior data according to a motion of the user; and
an environment identifying unit identifying the at least one static object according to the appearance data, and obtaining the environment data according to the identified at least one static object.

16. The smart control system according to claim 15, wherein the environment identifying unit receives a feedback signal from the at least one smart electronic apparatus, and updates the identified at least one static object according to the feedback signal.

17. The smart control system according to claim 16, wherein the feedback signal comprises an identification data of the at least one smart electronic apparatus, and the environment identifying unit updates the identified at least one static object according to the identification data.

18. The smart control system according to claim 16, wherein the environment identifying unit obtains a relative distance data regarding the at least one smart electronic apparatus according to an intensity of the feedback signal, and updates the identified at least one static object according to the relative distance data.

19. The smart control system according to claim 15, wherein the motion identifying unit receives a feedback signal from the at least one smart electronic apparatus, and updates the behavior data according to the feedback signal.

20. The smart control system according to claim 11, wherein the learning recording module further records a time of appearance of the user in a predetermined region to learn a work and rest mode of the user so as to generate the learning result.
